(19) United States
(12) Patent Application Publication
(10) Pub. No.: US 2026/0104677 A1
(43) Pub. Date: Apr. 16, 2026

(54) SYSTEM AND METHOD FOR HANDLING A REQUEST FOR AN INPUT PARAMETER FROM A CONTROLLER

(71) Applicant: VOLVO TRUCK CORPORATION, GÖTEBORG (SE)

(72) Inventor: Masoud Bakhshi, Gothenburg (SE)

(21) Appl. No.: 19/351,380

(22) Filed: Oct. 7, 2025

(30) Foreign Application Priority Data
Oct. 14, 2024 (EP) 24206307.1

(51) Int. Cl. G05B 13/02

(52) U.S. Cl. CPC G05B 13/024

(57) ABSTRACT

A computer system for handling a reference parameter from a controller. The reference parameter is associated with operation of a machine arranged to be controlled by the controller. The computer system comprising processing circuitry configured to receive the reference parameter from the controller, determine an output parameter based on the reference parameter, compare the determined output parameter with an output parameter limit, and to, when a result of comparison indicates that the determined output parameter exceeds the output parameter limit, determine a new output parameter based on the reference parameter and a present availability of a resource at the controller.

### CROSS REFERENCE TO RELATED APPLICATION

This application claims foreign priority to European Application No. 24206307.1 filed on Oct. 14, 2024, the disclosure and content of which is incorporated by reference herein in its entirety.

### TECHNICAL FIELD

The disclosure relates generally to a computer system, a computer-implemented method, a computer program product and a non-transitory computer-readable storage medium. In particular aspects, the disclosure relates to handling a request for an input parameter from a controller. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

When a vehicle starts to accelerate from a standstill, starting uphill or any other sudden requests, a controller may request several hundred volts or torque, depending on the type of controller used, e.g. speed or current controller. However, if there is a lack of available voltage, the controller may become saturated and lose controllability. This could also lead to windup, causing oscillations and long settling times. It is important to protect the controller from saturation to avoid these issues.

To prevent the controller from requesting more voltage or torque than is available and causing saturation, a limiter is often used in the controller's output, which causes saturation, too. In some cases, anti-windup techniques are used to protect the controller from saturation. However, even with these techniques, saturation can still occur in practice.

In view of the above, there is a striving to develop further improved technology relating to avoiding saturation in a controller while maintaining the controllability of the controller.

### SUMMARY

According to the first aspect of the disclosure, a computer system for handling a reference parameter from a controller is provided. The reference parameter is associated with the operation of a machine arranged to be controlled by the controller. The computer system comprises processing circuitry configured to:
receive the reference parameter from the controller;
determine an output parameter based on the reference parameter;
compare the determined output parameter with an output parameter limit and to
when a result of comparison indicates that the determined output parameter exceeds the output parameter limit, determine a new output parameter based on the reference parameter and a present availability of a resource at the controller, wherein the resource is associated with the reference parameter.

The first aspect of the disclosure may seek to provide improved handling of the reference parameter from the controller. A technical benefit may include that the handling of the reference parameter from the controller is improved. The disclosure enables linear acceleration and eliminates the risk of saturation. The new output parameter is determined to reduce the reference parameter to the one that is approachable based on available resources, e.g. availability of the resource at the controller, which results in a reduced risk for saturation or that the saturation is removed completely. The resource may be associated with the reference parameter in that the resource and the parameter in the term reference parameter may be the same. For example, the resource is current when the reference parameter is reference current. In another example, the resource is voltage when the reference parameter is a reference voltage. The determined output parameter is processed by comparing it to an output parameter limit and adjusting if necessary by determining a new reference parameter, which at the end results in linear acceleration. The output parameter limit may be based on the availability of the resource at the controller. Since the new output parameter does not exceed the output parameter limit, the risk for the controller becoming saturated is reduced or even mitigated. The disclosure achieves linear acceleration in the machine, in addition to having a robust controller without saturation issues. This will enable almost identical acceleration times for all produced vehicles, regardless of tolerances in vehicle manufacturing. The disclosure has a fast settled time, i.e. response time, and it provides controllability of the machine at almost any reference parameter compared to an anti-windup technique, for instance.

The disclosure improves the controller's availability for all resources, preventing it from entering the saturation area. This means the controller can take responsibility for and protect the vehicle under many circumstances.

With the disclosure, power switching devices will no longer be overestimated. For example, instead of selecting a 900 A IGBT when a 600 A IGBT is needed to account for overcurrent during saturation, a more tailor made device may be selected having only the necessary requirements. Additionally, by reducing harsh operating conditions such as high overcurrent, the lifetime of power devices will be increased. Furthermore, it is possible to operate safely in variable fundamental frequencies and bandwidths. Moreover, the driving range will be extended because there will be no overshoots and less dissipation.

Optionally, in some examples, including at least one preferred example, the processing circuitry may be further configured to trigger the controller to apply the new output parameter.

A technical benefit may include improved handling of the reference parameter from the controller.

Optionally, in some examples, including at least one preferred example, the processing circuitry may be further configured to trigger the controller to apply the output parameter when a comparison result indicates that the determined output parameter does not exceed the output parameter limit.

A technical benefit may include the fact that it is not necessary to determine and/or use the new output parameter. The determined output parameter may be applied without risking saturation in the controller since it does not exceed the output parameter limit.

Optionally in some examples, including in at least one preferred example, the new output parameter may be determined based on the reference parameter and the present availability of the resource at the controller in each sample time.

A technical benefit may include that handling of the reference parameter from the controller is improved. Determining the new output parameter in each sample ensures that the available resources are not exceeded and maintains continuous controllability.

Optionally in some examples, including in at least one preferred example, wherein the reference parameter may be one of: a reference speed, a reference voltage, a reference current and a reference torque. The determined output parameter may be one of: an output speed, an output voltage, an output current and an output torque. The output parameter limit may be one of: output speed limit, an output voltage limit, an output current limit and an output torque limit. The new output parameter may be at least one of: a new output speed, a new output voltage, a new output current and a new output torque. The resource may be at least one of: speed, voltage, current and torque.

A technical benefit may include that handling of the reference parameter from the controller is improved.

Optionally in some examples, including in at least one preferred example, the output parameter limit may comprise a range. The range may comprise a minimum output parameter limit and a maximum output parameter limit of the controller.

A technical benefit may include that the output parameter limit may be tailored to the specific machine that should operate on the determined output parameter or the new output parameter so that the operation is as optimal as possible, reduces the risk for saturation to a highest possible degree and to ensure linear acceleration of the vehicle.

Optionally in some examples, including in at least one preferred example, the controller may be a Proportional Integral (PI) controller or a Proportional Integral Derivative (PID) controller.

A technical benefit may include that handling of the reference parameter from the controller is improved.

Optionally in some examples, including in at least one preferred example, the controller may be one of: a torque controller, a speed controller, a current controller, a voltage controller, a position controller and a field weakening controller.

A technical benefit may include that handling of the reference parameter from the controller is improved.

Optionally in some examples, including in at least one preferred example, the machine arranged to be controlled by the controller may be comprised in a vehicle or an industrial machine.

A technical benefit may include that handling of the reference parameter from the controller is improved. When the handling of the reference parameter is improved, the risk for saturation in the controller is reduced or even mitigated. The reduced risk for saturation or the mitigation of the saturation improves efficiency of the vehicle, it ensures that the vehicle can operate closer to its optimal efficiency, it reduces energy efficiency, minimizes the need for maintenance and improves performance, just to mention some examples.

According to a second aspect of the disclosure, a vehicle comprising the computer system of the first aspect is provided. The second aspect of the disclosure may seek to provide improved handling of the reference parameter from the controller. A technical benefit may include that the handling of the reference parameter from the controller is improved.

The technical benefits of the second aspect are largely analogous to the technical benefits of the first aspect. It shall also be noted that all examples of the first aspect are combinable with all examples of the second aspect, and vice versa.

According to a third aspect of the disclosure, a computer-implemented method for handling a reference parameter from a controller is provided. The reference parameter is associated with the operation of a machine arranged to be controlled by the controller. The method comprises:
receiving, by processing circuitry of a computer system, the reference parameter from the controller;
determining, by the processing circuitry, an output parameter based on the reference parameter;
comparing, by the processing circuitry, the determined output parameter with an output parameter limit; and
when a result of the comparison indicates that the determined output parameter exceeds the output parameter limit, determining, by the processing circuitry, a new output parameter based on the reference parameter and present availability of a resource at the controller, wherein the resource is associated with the reference parameter.

The third aspect of the disclosure may seek to provide improved handling of the reference parameter from the controller. A technical benefit may include that the handling of reference parameters from the controller is improved.

Optionally in some examples, including in at least one preferred example, the method may further comprise:
triggering, by the processing circuitry, the controller to apply the new output parameter.

Optionally in some examples, including in at least one preferred example, the method may further comprise:
triggering, by the processing circuitry, the controller to apply the determined output parameter when a result of comparison indicates that the determined output parameter does not exceed the output parameter limit.

Optionally in some examples, including in at least one preferred example, the new output parameter may be determined based on the reference parameter and the present availability of the resource at the controller in each sample time.

Optionally in some examples, including in at least one preferred example, the reference parameter may be one of: a reference speed, a reference voltage, a reference current and a reference torque. The output parameter may be one of: an output speed, an output voltage, an output current and an output torque. The output parameter limit may be one of: an output speed limit, an output voltage limit, an output current limit and an output torque limit. The new output parameter may be at least one of: a new output speed, a new output voltage, a new output current and a new output torque. The resource may be at least one of: speed, voltage, current and torque.

Optionally in some examples, including in at least one preferred example, the output parameter limit may comprise a range comprising a minimum output parameter limit and a maximum output parameter limit of the controller.

Optionally in some examples, including in at least one preferred example, the controller may be a PI controller or a PID controller.

Optionally in some examples, including in at least one preferred example, the controller may be one of: a torque controller, a speed controller, a current controller, a voltage controller, a position controller and a field weakening controller.

Technical benefits of the third aspect are largely analogous to the technical benefits of the first and second aspects. It shall also be noted that all examples of the first and second aspects are combinable with all examples of the third aspect, and vice versa.

According to a fourth aspect of the disclosure, a computer program product is provided. The computer program product comprises program code for performing, when executed by a processing circuitry, the method of the third aspect.

The fourth aspect of the disclosure may seek to provide improved handling of the reference parameter from the controller. A technical benefit may include that the handling of reference parameter from the controller is improved.

Technical benefits of the fourth aspect are largely analogous to the technical benefits of the first, second and third aspects. It shall also be noted that all examples of the first, second and third aspects are combinable with all examples of the fourth aspect, and vice versa.

According to a fifth aspect of the disclosure, a non-transitory computer-readable storage medium is provided. The non-transitory computer-readable storage medium comprises instructions, which when executed by a processing circuitry, cause the processing circuitry to perform the method of the third aspect.

The fifth aspect of the disclosure may seek to provide improved handling of the reference parameter from the controller. A technical benefit may include that the handling of reference parameter from the controller is improved.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended

### DRAWINGS

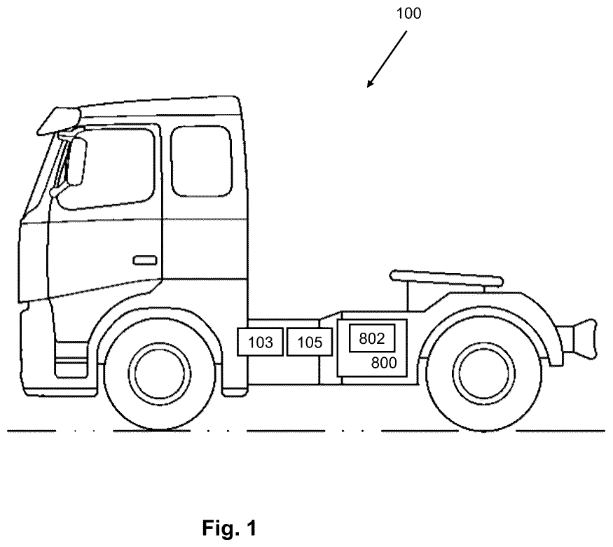

FIG. 1 is an exemplary drawing illustrating a vehicle, according to an example.

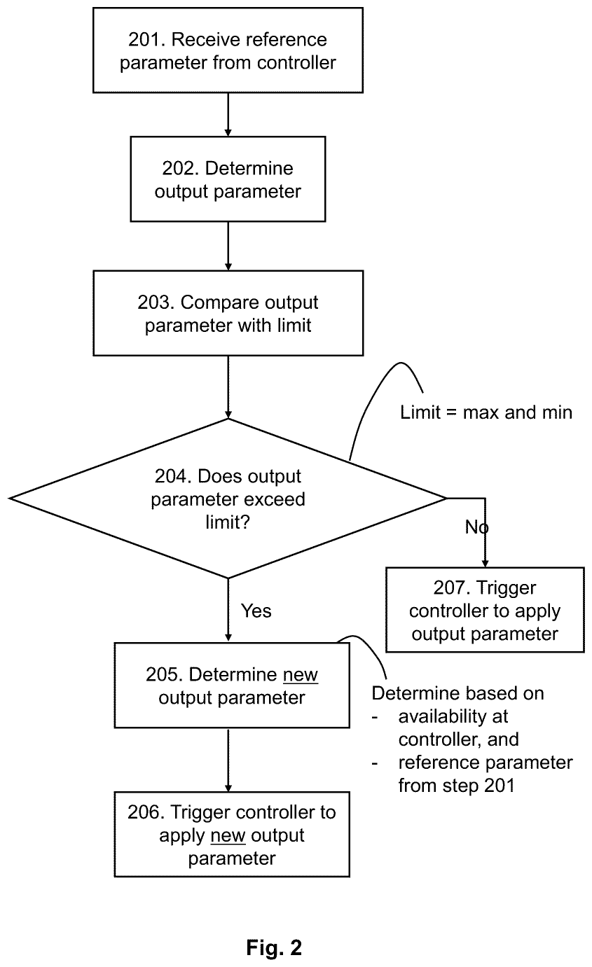

FIG. 2 is a flow chart of an exemplary method, according to an example.

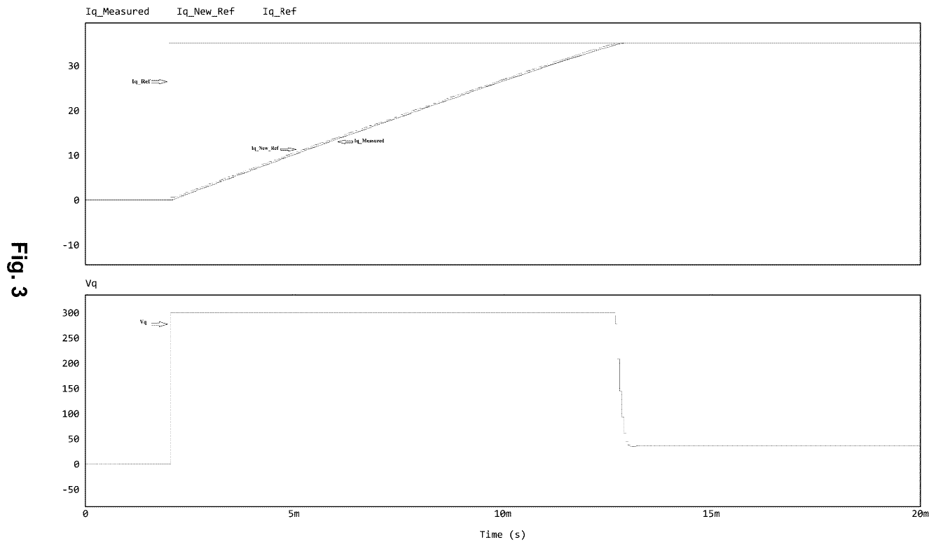

FIG. 3 are diagrams illustrating simulations, according to an example.

FIG. 4 are diagrams illustrating simulations, according to an example.

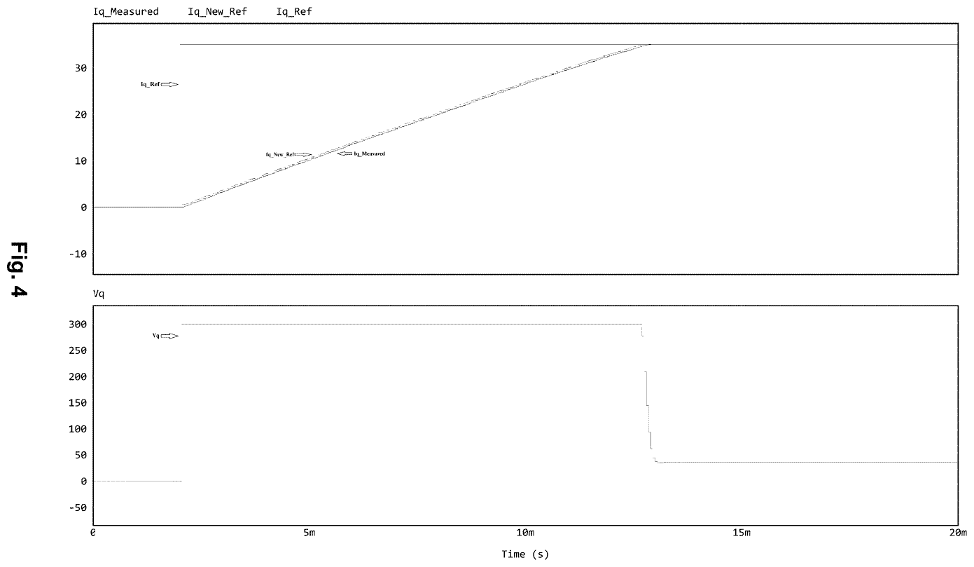

FIG. 5 are diagrams illustrating simulations, according to an example.

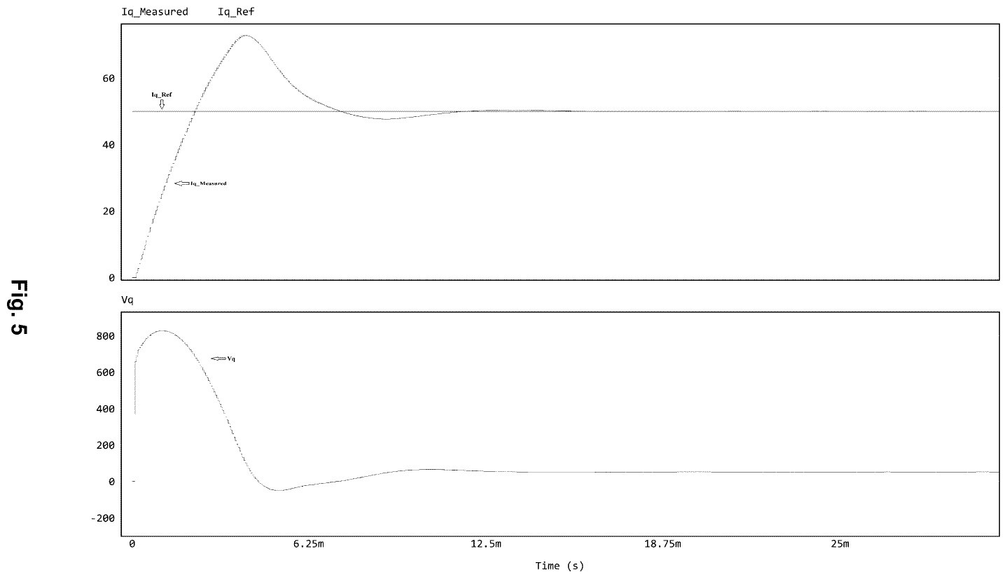

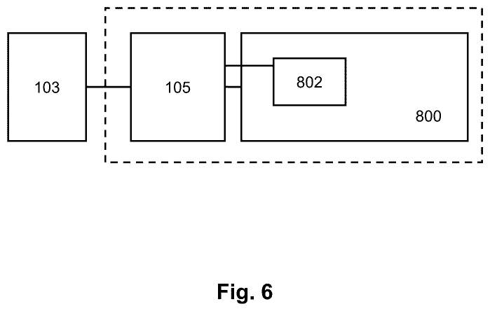

FIG. 6 is another view of FIG. 1, according to an example.

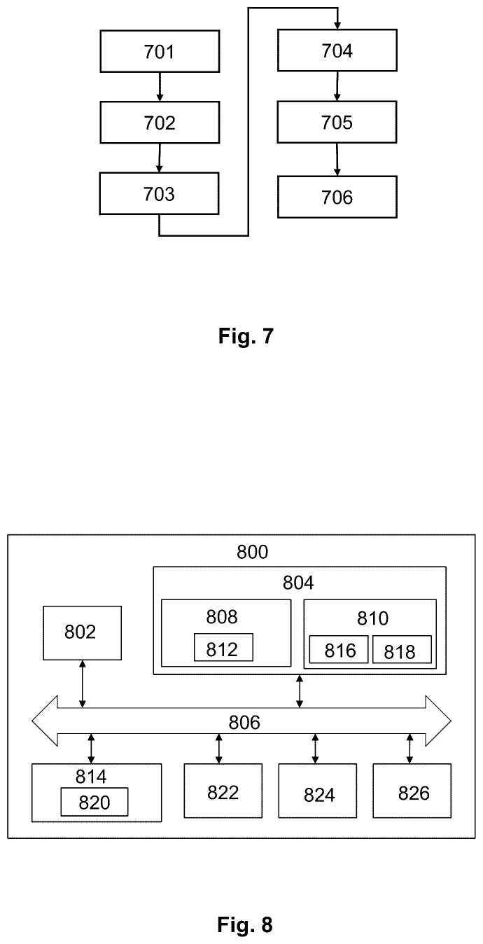

FIG. 7 is a flow chart of an exemplary method, according to an example

FIG. 8 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

When a vehicle starts to accelerate from a standstill or any other sudden requests, a controller may request several hundred volts or torque, depending on the type of controller used, e.g. speed or current controller. However, if there is a lack of available Direct Current (DC)-Link voltage, the controller may become saturated and lose controllability. This could also lead to windup, causing oscillations and long settling times. It is important to protect the controller from saturation to avoid these issues.

To prevent the controller from requesting more voltage or torque than is available and causing saturation, a limiter is often used in the controller's output, which is causing saturation too. In some cases, anti-windup techniques are used to protect the controller from saturation. However, even with these techniques, saturation can still occur in practice.

In view of the above, there is a strive to develop further improved technology relating to avoiding saturation in a controller.

It is beneficial to achieve linear acceleration in an electric machine, especially when it is connected to a truck, in addition to having a robust controller without saturation issues. This will enable almost identical acceleration times for all the vehicles produced. None of the current solutions nowadays can handle both concerns once, even if they are not providing complete solutions for saturation problems in practice. The present disclosure provides a complete solution for both concerns as a package. The present disclosure provides fast settled time, i.e. respond time, and controllability of the machine at almost any reference value compared to an anti-windup technique, for instance.

The present disclosure is applicable for all controllers in traction application, for instance, torque controller, speed controller, and current controller. The present disclosure is also applicable to any industrial machine.

The present disclosure ensures complete protection against controller saturation in practice. This guarantees the controller's availability for all resources, preventing it from entering the saturation area. This means that the controller can take responsibility for and protect the system under all circumstances. High-current components like IGBTs/Sic Mosfets also benefit from this, causing fewer spikes, surges, and overshoots. This improvement in durability is expected to occur. In addition to preventing saturation, the present disclosure also enables linear acceleration. In other words, no separate solution for linear acceleration is necessary since the present disclosure enables both linear acceleration and prevents saturation.

FIG. 1 is an exemplary drawing illustrating a vehicle 100, according to an example. The vehicle 100 is a heavy-duty vehicle, such as truck, bus, and construction equipment, among other vehicle types. Although the disclosure may be described with respect to a particular vehicle, the disclosure is not restricted to any particular vehicle, but may be also used in other vehicles such as, trailers, wheel loaders, articulated haulers, excavators, backhoe loaders, passenger cars, marine vessels etc. It may also be applied in various industrial construction machines or working machines.

The vehicle 100 may be a truck for towing one or more trailers (not shown). It shall however be understood that the vehicle may be any other type of vehicle, such as another type of truck, a bus, a passenger car, and construction equipment, such as an excavator, a wheel loader, etc. The vehicle 100 may be operated by a user (not shown) and/or be at least partly automatically driven, i.e., it may be a vehicle comprising autonomous driving capabilities. The user may be a driver of the vehicle 100.

The vehicle 100 may be a fully electric vehicle or a hybrid vehicle. The vehicle 100 may comprise at least one electric motors/generators and/or an internal combustion engine (not shown) for driving the vehicle 100. The term vehicle will be used herein when referring to any of the above types of vehicles.

The vehicle 100 comprises at least one machine 103. Using other words, the vehicle 100 comprises n machines 103, where n is a positive integer. The term machine 103 will be used herein when referring to the n machines 103. The machine 103 may be an electric machine. The machine 103 may be associated with the vehicle's propulsion system, the vehicle's braking system etc. The machine 103 may be an electric motor arranged to convert electric energy into mechanical energy to drive the wheels of the vehicle 100, it may be a generator arranged to convert mechanical energy into electrical energy to charge a battery comprised in the vehicle 100, it may be a generator arranged to convert kinetic energy into electric energy during regenerative braking, just to mention some examples. The machine 103 may function as both an electric motor and a generator. The machine 103 may be any type of electric machine used in traction applications, such as vehicles, boats, and trains. In other words, the machine 103 may not only be applicable to vehicles. The machine 103 may be any type of machine, for example Surface mounted Permanent Magnet synchronous machine (SPM), Interior Permanent Magnet (IPM) machine, Induction Motor (IM) machine, etc.

The vehicle 100 comprises a controller 105. The controller 105 is arranged to control a function of the vehicle 100, in particular for example a function of the machine 103. The function may be associated with for example torque, speed, current, voltage etc. Torque, speed, current and voltage may be examples of resources available to the controller 105.

The controller 105 may be, for example, a PI controller or a PID controller. Both the PI controller and PID controller are types of feedback control units and are arranged to control functions in, for example, the vehicle 100, an industrial machine in any other industrial application, etc. The PI controller comprises a proportional component and an integral component. The proportional component reacts to current error, the integral component is associated with accumulated errors. The PID controller comprises the proportional component, the integral component and a derivative component. The proportional and integral components of the PID controller are the same as for the PI controller. The derivative components are related to prediction of future errors. A difference between the PI controller and the PID controller is that the PI controller does not comprise the derivative part of the PID controller. The PI controller is well-suited for systems where speed and accuracy are important, but where precis and fast response control are not required. The PID controller is well-suited for systems requiring precis control and fast response to error changes. The controller 105 may be used in automotive and industrial applications.

The controller 105 may be one of:
a torque controller,
a speed controller,
a current controller,
a voltage controller,
a position controller and
a field weakening controller, and
any other high bandwidth controller.

The bandwidth of the controller 105, along with the sensors used for feedback, determine the achievable quality of control. In order to use high bandwidth controllers, a robust system first needs to be created. This disclosure ensures that the system may operate at high bandwidth without any issues. As power switch technology evolves, such as the use of Sic Mosfets, it is possible to increase the switching frequency to higher levels than before. For example, it is possible to move from 10 KHz to 60 KHz. With this increase in switching frequency, it is possible to enhance the bandwidth of the controller 105, allowing for more precise control of the machine 103.

Even though the controller 105 is described herein to be comprised in a vehicle 100, the controller 105 may equally be comprised in any industrial machine, for example tier manufacturing machines, train propulsion systems, aircrafts, just to mention some examples.

FIG. 2 is a flow chart of an exemplary method, according to an example. The method may be performed by a computer system 400 or a processing circuitry 402 comprised in the computer system 400. The computer system 400 may be located onboard the vehicle 100 or offboard the vehicle 100. The computer system 400 may be comprised in the controller 105, i.e. the method may be described as being performed by the controller 105. The method comprises at least one of the following steps, which steps may be performed in any suitable order than described below.

Step 201: A reference parameter is received from the controller 105. The reference parameter may be a reference speed, a reference voltage, a reference torque, just to mention some examples. The reference parameter may be referred to as an input parameter, a reference input parameter, a requested reference parameter, a requested parameter or a first parameter. The reference parameter may be associated with a resource such as for example speed, voltage, current and torque, just to mention some examples. The controller 105 wants to control operation of the machine 103 using the reference parameter, i.e. the reference parameter is requested by the controller 105. For example, when starting to accelerate the vehicle 100 from standstill, the controller 105 may request a certain number of volts to be applied to the machine 103. The number of volts requested by the controller 105 is the reference parameter in this example. If the requested amount of voltage is not available at the DC-link, the controller 105 may become saturated and lose controllability. To avoid this, at least one of the following steps is performed. Note that the number of volts is only an example, and that other types of reference parameters are equally applicable.

Step 202: An output parameter is determined based on the reference parameter that was received in step 201. The output parameter may be determined using any suitable method. The output parameter determined in step 202 may be referred to as a first output parameter or a second parameter. The output parameter is to be output by the controller 105, according to the reference parameter. However, this determined output parameter does not take the availability of the resource at the controller 105 into account. The determined output parameter may therefore exceed the availability of the resource at the controller 105, which may lead to saturation. In order to avoid this, at least one of steps 203-206 is performed.

Step 203: The output parameter that was determined in step 202 is compared with an output parameter limit. The output parameter limit may be based on the availability of the resource at the controller 105, for example the availability of at least one of: speed, voltage, current and torque. The output parameter limit may be predetermined. The output parameter may be fixed or it may be continuously and dynamically changed when necessary.

Step 204: A check is done to determine if a result of the comparison in step 203 indicates that the determined output parameter exceeds the output parameter limit. The output parameter limit may be an output parameter range comprising a maximum output parameter and a minimum output parameter. The determined output parameter may be either inside or outside the range. If the determined output parameter exceeds the output parameter limit, as indicated with “yes” in FIG. 2, the method proceeds to step 205. If the determined output parameter does not exceed the output parameter limit, as indicated with “no” in FIG. 2, the method proceeds to step 207.

For example, the output parameter range may comprise max 800 Volts and minimum −800 Volts.

Steps 203 and 204 may comprise at least one of equations (4), (8), (9), (10), (11), and (12) below.

Step 205: This step may be performed if the determined output parameter exceeds the output parameter limit. A new output parameter is determined if the determined output parameter exceeds the output parameter limit. The new output parameter is not determined when the result of comparison indicates that the determined output parameter does not exceed the output parameter limit. The output parameter determined in step 205 may be a second output parameter or a third parameter. The new output parameter may be a new reference parameter. The new output parameter may be a new reference parameter that is within the output parameter limit and that takes the availability of the reference into account. A new output parameter may be such that it does not exceed what is available to the controller 105, i.e. the availability of the resource such as for example voltage, current, speed and torque. The resource may be associated with at least one of: the reference parameter and the output parameter. The new output parameter may be re-determined or recalculated at every sample time until we reach the original reference parameter from step 201. The new output parameter is determined to be one that does not exceed the output parameter limit, e.g. that is within the output parameter range.

For example, if the output parameter of 1500 Volts is outside the output parameter range of 800-(−800) Volts, then the new reference value will be determined to keep the output below 800 Volts.

For instance, if the reference parameter is a reference current of 600 amperes and the vehicle 100 is at a standstill, for instance, the available voltage to controller 105 may be 800 volts, then the output of the controller 105 should not exceed 800 volts. The requested reference current may be adjusted to a value that finally can reach 600 A based on the available voltage. This adjustment will ensure that the reference current reaches the desired 600 A as quickly as possible without requiring a voltage higher than 800 volts. During the mentioned controlling time, saturation will not be touched; then there will be controllability in every step.

If the present availability of the resource is higher than the reference parameter, then the output parameter may be determined to be the same as the reference parameter. If the present availability of the resource is lower than the reference parameter, then the output parameter may be determined to be below the same as or below what is presently available. If the controller's requested voltage, for instance, is lower than the available DC-Link, it will allow the controller to work normally and will not modify the reference current.

In the example where the reference parameter is a reference voltage, then the present availability of resource being a voltage may be an online value of the battery status, which also shows the battery voltage. Information indicating the present availability of voltage may be obtained through CAN signal. There may be a voltage sensor on the DC-Link, which may directly measure the amplitude of traction voltage which shows the voltage limit, i.e. a direct measurement. For the examples where the reference parameter is a reference torque or reference speed, there may be mapping and calculations which calculates limits online based on current situation of the system.

The new output parameter may comprise one or two parts, for example both a new output speed and a new output torque. The two parts may comprise a first new output parameter and a second new output parameter. See Table 1 for more examples.

Step 205 may be repeated until the reference parameter from step 201 is reached.

Step 205 may comprise at least one of equations (10), (11) and (12) below.

Step 206: The controller 105 is triggered to apply the new output parameter. The triggering may comprise to send instructions to the controller 105 to apply the new output parameter, e.g. the second output parameter. The instructions may comprise information indicating the new output parameter. Consequently, the controller 105 applies the new output parameter in its control of the machine 103. The new output parameter does not exceed the output parameter limit and takes the reference parameter and the availability of the resource into account. Thus, saturation is avoided, and linear acceleration is achieved.

Step 207: This step is performed if the determined output parameter does not exceed the output parameter limit. For example, if the controller's requested output value, for instance, is lower than what is available on the DC-Link, it will allow the controller 103 to work normally and will not modify the reference current.

The controller 105 is triggered to apply the output parameter that was determined in step 202, e.g. the first output parameter. The triggering may comprise to send instructions to the controller 105 to apply the determined output parameter. The instructions may comprise information indicating the output parameter. Consequently, the controller 105 applies the output parameter in its control of the machine 103.

An overview of some examples of the controller 105, the reference parameter, the output parameter, the output parameter limit and the new output parameter is provided in Table 1 below. For example, when the reference parameter is a reference speed, then the output parameter is output torque, the output parameter limit is an output torque limit, and the new output parameter is a new output speed and a new output torque. The type of parameter is dependent on the type of controller 105.

TABLE 1

| | | | Output | |
|---|---|---|---|---|
| | Reference | Output | parameter | |
| Controller | parameter | parameter | limit | New output parameter |
| Speed | Reference | Output | Output | New Reference Speed |
| controller | speed | Torque | Torque | and Output Torque |
| | | | limit | |
| Voltage | Reference | Output | Output | New Reference Voltage |
| controller | voltage | current | Current | and Output Current |
| | | | limit | |
| Current | Reference | Output | Output | New Reference Current |
| controller | current | voltage | Voltage | and Output Voltage |
| | | | limit | |
| Torque | Reference | Output | Output | New Reference Torque |
| controller | torque | current | Current | and Output Current |
| | | | limit | |

Below is a list with an overview of the different terms that may be used for the different parameters:
Reference parameter:
   Input parameter
   Reference input parameter
   Requested reference parameter
   Requested parameter
   Requested input
   First parameter
Output parameter:
   First output parameter.
   Second parameter
New output parameter:
   second output parameter
   Third parameter

The method described herein will now be described using a PI controller as an example. Note that the method is equally applicable to any other controller, as mentioned earlier.

The present disclosure comprises implementing the code into the PI controller differential equation instead of using a limiter block in the controller's output.

A transfer function of a complex vector synchronous frame PI controller may be:

$${W}_{( S )} = {K}_{p} * ( 1 + \frac{1 + j ω t}{St} ) \qquad ( 1 )$$

$$t = \frac{{K}_{p}}{{K}_{i}} , \qquad ( 2 )$$

where W_{(S)} represents the transfer function in the Laplace domain Kₚ represents the proportional gain of the system, j represents the imaginary unit, ω represents the angular frequency, t represents a time constant, S represents the Laplace transform variable and Kᵢ represents an integral gain.

After using Tustin digitalization method

$$( s = \frac{2}{T} \frac{( Z - 1 )}{( Z + 1 )} where T = \frac{1}{{F}_{s w}} )$$

we have:

$${W}_{( z )} = \frac{( {K}_{p} + {K}_{i} \frac{T}{2} + {K}_{p} j ω \frac{T}{2} ) z + ( - {K}_{p} + {K}_{i} \frac{T}{2} + {K}_{p} j ω \frac{T}{2} )}{z - 1} , \qquad ( 3 )$$

where T represents the sampling period, F_{sw} represents the switching frequency, z represents the z-domain. Note that capital T represents the sampling period which is equal to 1/F_{sw}, while the lower case t represents a time constant.

Note that the Tusting digitalization method is only an example, and that any other suitable digitalization method can be used, for example Eurler's Method, Zero-Order Hold (ZOH) and Frist-Order Hold (FOH).

The differential equation to use in the controller 105 may be:

$${V}_{d q} = {V}_{d q - 1} + {K}_{1} \cdot ek + {K}_{2} \cdot {ek}_{- 1} \qquad ( 4 )$$

So that:

$${K}_{1} = {K}_{p} + {K}_{i} \frac{T}{2} + {K}_{p} j ω \frac{T}{2} \qquad ( 5 )$$

$${K}_{2} = - {K}_{p} + {K}_{i} \frac{T}{2} + {K}_{p} j ω \frac{T}{2} \qquad ( 6 )$$

ek₋₁=Previous error and ek=error

$${V}_{d q} = {V}_{d q - 1} + {K}_{1} \cdot ek + {K}_{2} \cdot {ek}_{- 1} \qquad ( 7 )$$

$$if {V}_{d q} > {V}_{dq - HIgher Limit} \qquad ( 7 )$$

Or → to check the limits defined for the controller 105.

$$if {V}_{d q} < {V}_{dq - Lower Limit} \qquad ( 8 )$$

$$ek = \frac{{V}_{d q - {V}_{d q - 1} - {K}_{2} \cdot {ek}_{- 1}}}{{K}_{1}} \qquad ( 9 )$$

$${i}_{dq}^{*} = {i}_{d q} + e k \qquad ( 10 )$$

$${ek}_{- 1} = ek , \qquad ( 11 )$$

where i_{dq} represents the measured dq-axis current and i_{dg}* represents the reference dq-axis current.

A new output parameter i_{dg}*, e.g. a new reference current, may be determined in case the controller 105 exceeds the higher limit V_{dq-Higher Limit} or the lower limit V_{dq-Lower Limit}. Thus, linear acceleration will be obtained.

Some simulations of control of machine 103 will now be described with reference to FIG. 3, FIG. 4 and FIG. 5. FIG. 3 and FIG. 4 both illustrate simulations using the present disclosure. FIG. 5 illustrates a simulation without the present disclosure.

FIG. 3 is similar to FIG. 4, but with a different bandwidth to demonstrate that the response time is almost the same in different fundamental frequencies and bandwidths. FIG. 3 and FIG. 4 show the performance of the present disclosure at both higher and lower fundamental frequencies and bandwidths. The simulations in FIG. 3 and FIG. 4 are based on the same parameters, except for the parameter BWᵢ and fundamental frequency. BWᵢ is 500 Hz in the simulation in FIG. 3 and 1000 Hz in the simulation in FIG. 4. fundamental frequency is 500 Hz in the simulation illsutrated in FIG. 3 and 200 Hz in the simulation in FIG. 4.

Both FIG. 3 and FIG. 4 show four lines, i.e. graphs. Three lines in the top diagram and one graph in the bottom diagram. In the top diagram of both FIG. 3 and FIG. 4, there is one line representing the reference q-axis current, one line representing the newly calculated reference current, and one line representing the measured q-axis current. The line in the bottom diagram of both FIG. 3 and FIG. 4 represents the output of the controller 105, which should not exceed 300 volts, as defined. Almost 35 A is applied as the Iq_Ref (reference q-axis current), and the controller 105 tries to output high voltage to quickly reach the reference current. However, there is a voltage limitation of 300 volts, so it is not desired to exceed this limit. It may also be possible to ensure control at every sampling time. Therefore, the reference current (Iq_New_Ref) may be recalculated to ensure it does not exceed the defined voltage limitation. It gradually increases the reference current based on available voltage to reach the Iq_Ref.

A simulation of a machine 103 exemplified by a Permanent Magnet Synchronous Motor (PMSM) motor being controlled by a controller 103 exemplified by a complex vector synchronous frame PI current controller utilizing the method disclosed herein is illustrated in FIG. 3. The simulation is done based on the following parameters:

$$\begin{matrix}\begin{matrix}\begin{matrix}\begin{matrix}\begin{matrix}\begin{matrix}{F}_{s w} = 20 KHz \\ {L}_{q} = {L}_{d} = 0.0 \; 158 H\end{matrix} \\ R = 0.53 Ω\end{matrix} \\ {T}_{L} = 10 N \cdot m\end{matrix} \\ {BW}_{i} = 500 Hz ,\end{matrix} \\ {V}_{d q - Higher Limit} = 300\end{matrix} \\ {V}_{dq - Lower Limit} = - 300\end{matrix}$$

FIG. 3 shows four graphs, i.e. three graphs in the top diagram and one graph in the bottom diagram. The simulation in FIG. 3 is for a bandwidth of 500 Hz and a fundamental frequency of 500 Hz. The x-axis of the top diagram in FIG. 3 represents time measured in seconds and the y-axis represents current, i.e. Iq which represents the current in the quadrature axis (q-axis). The top diagram in FIG. 3 illustrates three lines illustrating Iq_measured, Iq_new_ref and Iq_ref. Iq_measured is determined by a current sensor, i.e. the measured q-axis current. Iq_new_ref is an example of the new output parameter determined in step 205 in FIG. 2, i.e. the newly calculated reference current. Iq_ref is an example of the reference parameter received in step 201 of FIG. 2, i.e. the reference q-axis current.

The graph in the bottom diagram in FIG. 3 represents the output of the controller 105 which does not exceed 300 Volts, as defined for it. The x-axis of the bottom diagram in FIG. 3 represents time measured in seconds and the y-axis represent voltage, i.e. Vq which represents the voltage applied along the q-axis. The bottom diagram illustrates one line representing Vq. A simulation of a machine 103 exemplified by a PMSM motor being controlled by a controller 103 exemplified by a synchronous frame PI current controller utilizing the method disclosed herein is illustrated in FIG. 4. The simulation is done based on the following parameters:

$$\begin{matrix}\begin{matrix}\begin{matrix}\begin{matrix}\begin{matrix}\begin{matrix}{F}_{s w} = 20 KHz \\ {L}_{q} = {L}_{d} = 0.0 \; 158 H\end{matrix} \\ R = 0.53 Ω\end{matrix} \\ {T}_{L} = 10 N \cdot m\end{matrix} \\ {BW}_{i} = 1000 Hz\end{matrix} \\ {V}_{d q - Higher Limit} = 300\end{matrix} \\ {V}_{dq - Lower Limit} = - 300\end{matrix}$$

FIG. 4 shows four graphs, i.e. three graphs in the top diagram and one graph in the bottom diagram. The x-axis of the top diagram in FIG. 4 represents time measured in seconds and the y-axis represents current, i.e. Iq which represents the current in the quadrature axis (q-axis). The top diagram in FIG. 4 illustrates three lines illustrating Iq_measured, Iq_new_ref and Iq_ref. Iq_measured is determined by a current sensor. Iq_new_ref is an example of the new output parameter determined in step 205 in FIG. 2. Iq_ref is an example of the reference parameter received in step 201 of FIG. 2.

The x-axis of the bottom diagram represents time measured in seconds and the y-axis represent voltage, i.e. Vq which represents the voltage applied along the q-axis. The bottom diagram illustrates one line representing Vq.

FIG. 5 is a simulation of a machine 103 exemplified by a PMSM motor being controlled by a controller 103 exemplified by a PI current controller without utilizing the method disclosed herein. The simulation in FIG. 5 is for a bandwidth of 200 Hz and a frequency of 50 Hz. The x-axis of the top diagram in FIG. 5 represents time measured in seconds and the y-axis represents current, i.e. Iq. Both the top and the bottom diagram illustrates two lines, one line for the Iq_Measured_PI which is an example of a parameter applied and outputted by the controller 103 and one line for the Iq_Ref_PI which is an example of the reference parameter received in step 203 in FIG. 2.

From FIG. 5, it can be observed that it takes a long time to rach the reference time, and that saturation will occur as the value is not limited to 300V. It requires around 800V, which will cause saturation when it requests more than 300V. This will affect controller performance and response time, both of which will vary with changes in bandwidth and fundamental frequencies. The same issue is present in Id_Measure_PI, where the requested Id_Ref_PI is 5, but the measured value overshoots.

FIG. 6 is another view of FIG. 1, according to an example. FIG. 6 illustrates a computer system 800 for handling a reference parameter from the controller 105. The reference parameter is associated with operation of the machine 103 arranged to be controlled by the controller 105. The computer system 800 comprises processing circuitry 802.

The controller 105 may be a PI controller or a PID controller.

The controller 105 may be one of: a torque controller, a speed controller, a current controller, a voltage controller, a position controller, a field weakening controller and any other high bandwidth controller in automotive and industrial applications.

The machine 103 arranged to be controlled by the controller 105 may be comprised in a vehicle 100 or an industrial machine.

The computer system 800 may be a standalone system arranged to communicate with the controller 105, or the computer system 800 may be co-located or comprised in the controller 105, as illustrated with the dotted box around the controller 105 and the computer system 800. At least one entity illustrated in FIG. 6 may be comprised in the vehicle 100 or in the industrial system, i.e. at least one of: the machine 103, the controller 105, the computer system 800 and the processing circuitry 802 may be comprised in the vehicle 100 or the industrial system. The computer system 800 may be comprised in the vehicle 100 or in an industrial system, or it may be located offboard the vehicle 100 or the industrial system.

The processing circuitry 802 is configured to receive the reference parameter from the controller 105. The reference parameter may be one of: a reference speed, a reference voltage, a reference current and a reference torque. The type of reference parameter may be determined by the type of controller 105.

The processing circuitry 802 is configured to determine an output parameter based on the reference parameter.

The output parameter may be one of: an output speed, an output voltage, an output current and an output torque. The type of output parameter may be determined by the type of controller 105.

The processing circuitry 802 is configured to compare the determined output parameter with an output parameter limit. The output parameter limit may be based on the present availability of the resource at the controller 105.

The output parameter limit may be one of: output speed limit, an output voltage limit, an output current limit and an output torque limit. The type of output parameter limit may be determined by the type of controller 105.

The output parameter limit may comprise a range comprising a minimum output parameter and a maximum output parameter of the controller 105.

The processing circuitry 802 is configured to determine a new output parameter based on the reference parameter and a present availability of the resource at the controller 105. The resource is associated with at least one of the reference parameter and the output parameter. The new output parameter is determined when a result of comparison indicates that the determined output parameter exceeds the output parameter limit. The new output parameter is not determined when the result of comparison indicates that the determined output parameter does not exceed the output parameter limit.

The resource may be at least one of: speed, voltage, current and torque. The resource may be associated with the reference parameter in that the resource and the parameter in the term reference parameter and output parameter may be the same. The resource may be associated with the output parameter in that the resource and the parameter in the term output parameter may be the same, and similar for the output parameter. For example, the resource is current when the reference parameter is reference current. In another example, the resource is voltage when the reference parameter is a reference voltage.

The new output parameter may be determined based on the reference parameter and the present availability of the resource at the controller 105 in each sample time.

The new output parameter may be at least one of: a new output speed, a new output voltage, a new output current and a new output torque. The type of new output parameter may be determined by the type of controller 105.

The processing circuitry 802 may be configured to trigger the controller 105 to apply the new output parameter.

The processing circuitry 802 may be configured to trigger the controller 105 to apply the determined output parameter when a result of comparison indicates that the determined output parameter does not exceed the output parameter limit.

The vehicle 100 may comprise the computer system 800.

An industrial system may comprise the computer system 800.

FIG. 7 is a flow chart of a method for handling a reference parameter from a controller 105 according to an example. The reference parameter is associated with operation of a machine 103 arranged to be controlled by the controller 105. The controller 105 may be a PI controller or a PID controller. The controller 105 may be one of: a torque controller, a speed controller, a current controller, a voltage controller, a position controller, a field weakening controller and any other high bandwidth controller in automotive and industrial applications.

The method comprises at least one of the following steps, which steps may be performed in any suitable order than described below:

Step 701: This step corresponds to step 201 in FIG. 2. Receiving, by a processing circuitry 802 of the computer system 800, the reference parameter from the controller 105.

The reference parameter may be one of: a reference speed, a reference voltage, a reference current and a reference torque.

Step 702: This step corresponds to step 202 in FIG. 2. Determining, by the processing circuitry 802, an output parameter based on the reference parameter.

The determined output parameter may be one of: an output speed, an output voltage, an output current and an output torque.

Step 702: This step corresponds to steps 203 and 204 in FIG. 2. Comparing, by the processing circuitry 802, the determined output parameter with an output parameter limit.

The output parameter limit may be one of: an output speed limit, an output voltage limit, an output current limit and an output torque limit.

The output parameter limit may comprise a range comprising a minimum output parameter and a maximum output parameter of the controller 105.

Step 704: This step corresponds to step 205 in FIG. 2. Determining, by the processing circuitry 802, a new output parameter based on the reference parameter and on the present availability of the resource at the controller 105. The new output parameter is determined when a result of comparison indicates that the determined output parameter exceeds the output parameter limit. The resource is associated with at least one of the reference parameter and the output parameter.

The new output parameter may be determined based on the reference parameter and the present availability of the resource at the controller 105 in each sample time.

The resource may be at least one of: speed, voltage, current and torque. The resource may be associated with the reference parameter in that the resource and the parameter in the term reference parameter may be the same, and similar for the output parameter. For example, the resource is current when the reference parameter is reference current. In another example, the resource is voltage when the reference parameter is a reference voltage.

The new output parameter may be at least one of: a new output speed, a new output voltage, a new output current and a new output torque.

Step 705: This step corresponds to step 206 in FIG. 2. Triggering, by the processing circuitry 802, the controller 105 to apply the new output parameter.

Step 706: This step corresponds to step 207 in FIG. 2. Triggering, by the processing circuitry 802, the controller 105 to apply the determined output parameter when a result of comparison indicates that the determined output parameter does not exceed the output parameter limit.

A computer program product comprises program code for performing, when executed by the processing circuitry 802, the method disclosed herein.

A non-transitory computer-readable storage medium comprises instructions, which when executed by a processing circuitry 802, cause the processing circuitry 802 to perform the method disclosed herein.

FIG. 8 is a schematic diagram of a computer system 800 for implementing examples disclosed herein. The computer system 800 is adapted to execute instructions from a computer-readable medium to perform these and/or any of the functions or processing described herein. The computer system 800 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 800 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 800 may comprise at least one computing device or electronic device capable of including firmware, hardware, and/or executing software instructions to implement the functionality described herein. The computer system 800 may include processing circuitry 802 (e.g., processing circuitry including one or more processor devices or control units), a memory 804, and a system bus 806. The computer system 800 may include at least one computing device having the processing circuitry 802. The system bus 806 provides an interface for system components including, but not limited to, the memory 804 and the processing circuitry 802. The processing circuitry 802 may include any number of hardware components for conducting data or signal processing or for executing computer code stored in memory 804. The processing circuitry 802 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 802 may further include computer executable code that controls operation of the programmable device.

The system bus 806 may be any of several types of bus structures that may further interconnect to a memory bus (with or without a memory controller), a peripheral bus, and/or a local bus using any of a variety of bus architectures. The memory 804 may be one or more devices for storing data and/or computer code for completing or facilitating methods described herein. The memory 804 may include database components, object code components, script components, or other types of information structure for supporting the various activities herein. Any distributed or local memory device may be utilized with the systems and methods of this description. The memory 804 may be communicably connected to the processing circuitry 802 (e.g., via a circuit or any other wired, wireless, or network connection) and may include computer code for executing one or more processes described herein. The memory 804 may include non-volatile memory 808 (e.g., read-only memory (ROM), erasable programmable read-only memory (EPROM), electrically erasable programmable read-only memory (EEPROM), etc.), and volatile memory 810 (e.g., random-access memory (RAM)), or any other medium which can be used to carry or store desired program code in the form of machine-executable instructions or data structures and which can be accessed by a computer or other machine with processing circuitry 802. A basic input/output system (BIOS) 812 may be stored in the non-volatile memory 808 and can include the basic routines that help to transfer information between elements within the computer system 800.

The computer system 800 may further include or be coupled to a non-transitory computer-readable storage medium such as the storage device 814, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 814 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 814 and/or in the volatile memory 810, which may include an operating system 816 and/or one or more program modules 818. All or a portion of the examples disclosed herein may be implemented as a computer program 820 stored on a transitory or non-transitory computer-usable or computer-readable storage medium (e.g., single medium or multiple media), such as the storage device 814, which includes complex programming instructions (e.g., complex computer-readable program code) to cause the processing circuitry 802 to carry out actions described herein. Thus, the computer-readable program code of the computer program 820 can comprise software instructions for implementing the functionality of the examples described herein when executed by the processing circuitry 802. In some examples, the storage device 814 may be a computer program product (e.g., readable storage medium) storing the computer program 820 thereon, where at least a portion of a computer program 820 may be loadable (e.g., into a processor) for implementing the functionality of the examples described herein when executed by the processing circuitry 802. The processing circuitry 802 may serve as a controller or control system for the computer system 800 that is to implement the functionality described herein. The computer system 800 may include an input device interface 822 configured to receive input and selections to be communicated to the computer system 800 when executing instructions, such as from a keyboard, mouse, touch-sensitive surface, etc. Such input devices may be connected to the processing circuitry 802 through the input device interface 822 coupled to the system bus 806 but can be connected through other interfaces, such as a parallel port, an Institute of Electrical and Electronic Engineers (IEEE) 1394 serial port, a Universal Serial Bus (USB) port, an IR interface, and the like. The computer system 800 may include an output device interface 824 configured to forward output, such as to a display, a video display unit (e.g., a liquid crystal display (LCD) or a cathode ray tube (CRT)). The computer system 800 may include a communications interface 826 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Below follows a list of examples 1-20. Each example can be combined with any of the other examples discussed above.

Example 1: A computer system 800 for handling a reference parameter from a controller 105, wherein the reference parameter is associated with operation of a machine 103 arranged to be controlled by the controller 105, wherein the computer system 800 comprising processing circuitry 802 configured to:
receive the reference parameter from the controller 105;
determine an output parameter based on the reference parameter;
compare the determined output parameter with an output parameter limit; and to
when a result of comparison indicates that the determined output parameter exceeds the output parameter limit, determine a new output parameter based on the reference parameter and a present availability of the resource at the controller 105, wherein the resource is associated with the reference parameter.

Example 2: The computer system 800 of example 1, wherein the processing circuitry 802 is further configured to:
trigger the controller 105 to apply the new output parameter.

Example 3: The computer system 800 of any of examples 1-2, wherein the processing circuitry 802 is further configured to:
trigger the controller 105 to apply the determined output parameter when a result of comparison indicates that the determined output parameter does not exceed the output parameter limit.

Example 4: The computer system 800 of any of examples 1-3, wherein the new output parameter is determined based on the reference parameter and the present availability of the resource at the controller 105 in each sample time.

Example 5: The computer system 800 of any of examples 1-4, wherein the reference parameter is one of: a reference speed, a reference voltage, a reference current and a reference torque, wherein the output parameter is one of: an output speed, an output voltage, an output current and an output torque, wherein the output parameter limit is one of: output speed limit, an output voltage limit, an output current limit and an output torque limit, and wherein the new output parameter is at least one of: a new output speed, a new output voltage, a new output current and a new output torque.

Example 6: The computer system 800 of any of examples 1-5, wherein the output parameter limit comprises a range comprising a minimum output parameter and a maximum output parameter of the controller 105.

Example 7: The computer system 800 of any of examples 1-6, wherein the controller 105 is a PI controller or a PID controller.

Example 8: The computer system 800 of any of examples 1-7, wherein the controller 105 is one of: a torque controller, a speed controller, a current controller, a voltage controller, a position controller, a field weakening controller and any other high bandwidth controller in automotive and industrial applications.

Example 9: The computer system 800 of any of examples 1-8, wherein the machine 103 arranged to be controlled by the controller 105 is comprised in a vehicle (100) or an industrial machine.

Example 10: A vehicle 100 comprising the computer system 800 of any of examples 1-9.

Example 11: A computer-implemented method for handling a reference parameter from a controller 105, wherein the reference parameter is associated with operation of a machine 103 arranged to be controlled by the controller 105, the method comprising:
receiving 201, 701, by a processing circuitry 802 of a computer system 800, the reference parameter from the controller 105;
determining 202, 702, by the processing circuitry 802, an output parameter based on the reference parameter;
comparing 203, 204, 703, by the processing circuitry 802, the determined output parameter with an output parameter limit; and
when a result of comparison indicates that the determined output parameter exceeds the output parameter limit, determining 205, 704, by the processing circuitry 802, a new output parameter based on the reference parameter and a present availability of the resource at the controller 105, wherein the resource is associated with the reference parameter.

Example 12: The method of example 11, further comprising:
triggering 206, 705, by the processing circuitry 802, the controller 105 to apply the new output parameter.

Example 13: The method of any of examples 11-12, further comprising:
triggering 207, 706, by the processing circuitry 802, the controller 105 to apply the determined output parameter when a result of comparison indicates that the determined output parameter does not exceed the output parameter limit.

Example 14: The method of any of examples 11-13, wherein the new output parameter is determined based on the reference parameter and the present availability of the resource at the controller 105 in each sample time.

Example 15: The method of any of examples 11-14, wherein the reference parameter is one of: a reference speed, a reference voltage, a reference current and a reference torque, wherein the determined output parameter is one of: an output speed, an output voltage, an output current and an output torque, wherein the output parameter limit is one of: an output speed limit, an output voltage limit, an output current limit and an output torque limit, and wherein the new output parameter is at least one of: a new output speed, a new output voltage, a new output current and a new output torque.

Example 16: The method of any of examples 11-15, wherein the output parameter limit comprises a range comprising a minimum output parameter and a maximum output parameter of the controller 105.

Example 17: The method of any of examples 11-16, wherein the controller 105 is a PI controller or a PID controller.

Example 18: The method of any of examples 11-17, wherein the controller 105 is one of: a torque controller, a speed controller, a current controller, a voltage controller, a position controller, a field weakening controller and any other high bandwidth controller in automotive and industrial applications.

Example 19: A computer program product comprising program code for performing, when executed by a processing circuitry 802, the method of any of examples 11-18.

Example 20: A non-transitory computer-readable storage medium comprising instructions, which when executed by a processing circuitry 802, cause the processing circuitry 802 to perform the method of any of examples 11-19.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for handling a reference parameter from a controller, wherein the reference parameter is associated with operation of a machine arranged to be controlled by the controller, wherein the computer system comprising processing circuitry configured to:
receive the reference parameter from the controller;
determine an output parameter based on the reference parameter;
compare the determined output parameter with an output parameter limit; and to
when a result of comparison indicates that the determined output parameter exceeds the output parameter limit, determine a new output parameter based on the reference parameter and on a present availability of a resource at the controller, wherein the resource is associated with the reference parameter.

2. The computer system of claim 1, wherein the processing circuitry is further configured to:
trigger the controller to apply the new output parameter.

3. The computer system of claim 1, wherein the processing circuitry is further configured to:
trigger the controller to apply the determined output parameter when a result of comparison indicates that the determined output parameter does not exceed the output parameter limit.

4. The computer system of claim 1, wherein the new output parameter is determined based on the reference parameter and the present availability of the resource at the controller in each sample time.

5. The computer system of claim 1,
wherein the reference parameter is one of: a reference speed, a reference voltage, a reference current and a reference torque,
wherein the output parameter is one of: an output speed, an output voltage, an output current and an output torque,
wherein the output parameter limit is one of: output speed limit, an output voltage limit, an output current limit and an output torque limit, and
wherein the new output parameter is at least one of: a new output speed, a new output voltage, a new output current and a new output torque.

6. The computer system of claim 1, wherein the output parameter limit comprises a range comprising a minimum output parameter and a maximum output parameter of the controller.

7. The computer system of claim 1, wherein the controller is a Proportional Integral, PI, controller or a Proportional Integral Derivative, PID, controller.

8. The computer system of claim 1, wherein the controller is one of: a torque controller, a speed controller, a current controller, a voltage controller, a position controller and a field weakening controller.

9. The computer system of claim 1, wherein the machine arranged to be controlled by the controller is comprised in a vehicle or an industrial machine.

10. A vehicle comprising the computer system of claim 1.

11. A computer-implemented method for handling a reference parameter from a controller, wherein the reference parameter is associated with operation of a machine arranged to be controlled by the controller, the method comprising:
receiving, by a processing circuitry of a computer system, the reference parameter from the controller;
determining, by the processing circuitry, an output parameter based on the reference parameter;
comparing, by the processing circuitry, the determined output parameter with an output parameter limit; and
when a result of comparison indicates that the determined output parameter exceeds the output parameter limit, determining, by the processing circuitry, a new output parameter based on the reference parameter and a present availability of a resource at the controller, wherein the resource is associated with the reference parameter.

12. The method of claim 11, further comprising:
triggering, by the processing circuitry, the controller to apply the new output parameter.

13. The method of claim 11, further comprising:
triggering, by the processing circuitry, the controller to apply the determined output parameter when a result of comparison indicates that the determined output parameter does not exceed the output parameter limit.

14. A computer program product comprising program code for performing, when executed by a processing circuitry, the method of claim 11.

15. A non-transitory computer-readable storage medium comprising instructions, which when executed by a processing circuitry, cause the processing circuitry to perform the method of claim 11.
